(19) United States
(12) Patent Application Publication
(10) Pub. No.: US 2015/0382371 A1
(43) Pub. Date: Dec. 31, 2015

(54) METHOD AND SYSTEM FOR NETWORK-ASSISTED INTERFERENCE SUPPRESSION/CANCELATION

(71) Applicant: NEC Corporation, Tokyo (JP)

(72) Inventors: Le LIU, Tokyo (JP); Naoto ISHII, Tokyo (JP); Yoshikazu KAKURA, Tokyo (JP)

(73) Assignee: NEC CORPORATION, Tokyo (JP)

(21) Appl. No.: 14/766,645

(22) PCT Filed: Feb. 7, 2013
(86) PCT No.: PCT/JP2013/000665

§ 371 Date: Aug. 7, 2015

(51) Int. Cl. H04W 72/12; H04L 5/00; H04B 7/06; H04W 74/00; H04B 7/02

(52) U.S. Cl. CPC H04W 72/1231; H04W 74/006; H04B 7/024; H04B 7/0626; H04L 5/0048

(57) ABSTRACT

A system which can achieve effective interference suppression/cancelation in downlink coordinated multi-point (CpMP) transmission is provided. The system has a network including multiple points which are capable of communicating with a user equipment, wherein the network sends information related to an interfering point to the user equipment for interference suppression or cancelation at the user equipment, wherein the interfering point is a candidate for a coordinated multi-point measurement set of the user equipment but not selected for any coordinated multi-point scheme.

### TECHNICAL FIELD

The present invention relates generally to a radio communication system and, more specifically, to techniques of interference suppression/cancellation in downlink coordinated multi-point (CoMP) transmission.

### BACKGROUND ART

Coordinated multi-point transmission/reception is considered in LTE (Long Term Evolution)-Advanced Release 11(Rel. 11) as a tool to improve the coverage of high data rates, the cell-edge throughput, and also to increase the system throughput as described in the Sect. 4 of NPL1.

The CoMP schemes, joint transmission (JT), dynamic point selection (DPS), and coordinated scheduling/coordinated beamforming (CS/CB) have been agreed to be supported as described in the Sect. 5.1.3 of NPL1. For JT, multiple transmission points (TPs) are selected for simultaneous data transmission and the interference comes from the points other than the selected TPs. For DPS, only one TP is dynamically selected and the interference comes from the points other than the only selected TP. While, for CB/CS, the serving point is the only TP to transmit data but the strong interference from the neighbor cell is reduced significantly.

In NPL2, a set of channel state/statistical information-reference signal (CSI-RS) resources is defined as a CoMP resource management set (CRMS), for which CSI-RS received signal measurement can be made and reported. Within the CRMS, a CoMP measurement set (CMS) is defined in the Sect. 5.1.4 of NPL1 as a set of points about which CSI related to their link to a user equipment (UE) is measured and/or reported.

As illustrated in FIG. 1, it is assumed that Macro eNB and low power nodes LPN1 and LPN2, connected by optical fiber (backhaul), are grouped into a CoMP cooperating set for centralized scheduling at Macro eNB. FIG. 1 shows a case where UE1's CMS includes its serving point LPN1 and neighbor point Macro eNB; while UE2's CoMP measurement set includes only its serving point LPN2.

For the CRMS and CMS decision, the long-term measurements of received reference signals are made and reported by UE to its serving cell. For example, the reference signal received power (RSRP) defined in Sect. 5.1.1 of NPL3, is used for the CRMS and CMS decision. For example, as shown in FIG. 2, only the neighbor point satisfying that the difference between serving cell's RSRP, RSRPₛₑᵣᵥ, and neighbor cell's RSRP, RSRP_{neigh}, is smaller than a pre-defined threshold TH_{RSRP}, will be included in the CRMS, i.e., RSRPₛₑᵣᵥ-RSRP_{neigh}<TH_{RSRP}. From the CRMS, the maximum 3 top points in the RSRP ranking list are selected in the CMS for downlink CoMP in LTE Rel. 11.

In NPL4, for RRC-related aspects of the agreements reached in LTE RAN1 for downlink CoMP in LTE Rel. 11, a Rel. 11 UE can be configured to report one or more CSI processes per component carrier. Each CSI process is configured by the association of channel part, one non-zero power CSI-RS resource in the CMS, and interference part, one Interference Measurement Resource (CSI-IM) which occupies 4 REs that can be configured as a single zero power CSI-RS configuration. For CoMP, the CSI processes considering the interference power with or without muting on different cells in the CMS need to be estimated at UE side. The obtained channel state information (CSI), such as precoding vector index (PMI), rank index (RI) and channel quality index (CQI), is used for channel-dependent scheduling to support the variable CoMP schemes among multiple coordinated points in the CMS. In the present specification, a point for coordinated multi-point transmission/reception can be used as a technical term including a cell, base station, Node-B, eNB, remote radio equipment (RRE), distributed antenna, and the likes.

In LTE Rel. 11, besides the CSI-process configuration for CSI measurement and reporting, it was also agreed that the specification would provide signaling to indicate the cell-specific reference signal (CRS) position of at least one cell from which PDSCH transmission may occur, as well as the quasi-co-location assumption on DMRS. Up to 4 sets (states) per CC of PDSCH RE mapping and quasi-co-location (PQL) parameters can be configured using RRC signaling and indicated by downlink control information (DCI) format 2D. Each set that can be signaled in DCI format 2D for TM10 corresponds to a higher-layer list of the parameters listed in Table 5 in NPL4.

As illustrated in FIG. 3, the dense small cell scenarios in Heterogeneous Network (HetNet) are considered with large number of low power nodes (LPNs) and/or smaller inter-point distance in LTE Rel. 12. As the number of LPNs increases, the inter-point interference becomes significant, resulting in performance degradation.

As mentioned before, the maximum 3 points in the CRMS can be included in the CMS if their RSRP satisfying RSRPₛₑᵣᵥ-RSRP_{neigh}<TH_{RSRP}. Within the CMS, the limited number of points can be selected as transmission points (TPs) or CS/CB points to improve the spectrum efficiency at the transmitter side. For example, 2 TPs are selected for JT; one TP is selected for DPS; and one point is selected for CS/CB.

However, as illustrated in FIG. 4, strong precoded interferences from the following two types of points may result in significant degradation of user throughput:
Type_{—}1: A point in the CMS, which is not selected as a TP or a CS/CB point, may dynamically result in strong interference to a CoMP UE, e.g., Point 2 in the CMS of Points 0, 1 and 2 in FIG. 4; and
Type_{—}2: A point outside the CMS, which has high RSRP, may dynamically result in strong interference to a CoMP UE, e.g., Point 3 outside the CMS of Points 0, 1 and 2 in FIG. 4.

In FIG. 4, assuming that Points 0 and 1 are both selected for synchronized joint transmitting the data of the target UE0, the UE 30 receives the data based on minimum mean square error (MMSE) criterion by using the estimated channel matrix as follows. Assuming Xₛ is the transmit data signal to the target UE0 in the frequency domain, Xᵢ is the frequency-domain interfering data signal of the other UE, the received frequency-domain signal Y can be written by the following equation (1):

$$\begin{matrix}\{ Math . 1 \} & \\ Y = ( {\hat{H}}_{0} + {\hat{H}}_{1} ) {X}_{s} + {\sum }_{i \neq 0 , 1} {\hat{H}}_{i} {X}_{i} + N . & ( 1 )\end{matrix}$$

Hereafter, H-circumflex (̂) as in the above equation (1) is denoted by Ĥ convenience in writing. In the equation (1), Ĥᵢ is the precoded channel matrix at the point i and N is Additive White Gaussian Noise (AWGN). The signal data X~ₛ can be estimated by using the MMSE weight Wₛ^{MMSE} according to the following equation (2):

$$\begin{matrix}\{ Math . 2 \} & \\ {\tilde{X}}_{s} = {W}_{s}^{MMSE} Y \\ with {W}_{s}^{MMSE} = \frac{{\tilde{H}}_{s}^{H}}{{\tilde{H}}_{s} {\tilde{H}}_{s}^{H} + {σ}_{N + I}^{2}} \\ wherein {σ}_{N + I}^{2} is , & ( 2 )\end{matrix}$$

the average noise and interference. Hereafter, X-tilde, H-tilde (~) as in the above equation (2) are respectively denoted by X~, H~ for convenience in writing. In the equation (2), H~ₛ is the estimated equivalent channel which is nearly equal to Ĥ₀+Ĥ₁.

At this moment, Point 2 in the CMS is not selected (type_{—}1 point) and therefore, the transmission of the other UE's data at Point 2 may result in the strong interference to the target UE0. Also the interference from Point 3, which has high RSRP but not included the CMS (type_{—}2 point) may also reduce the SINR of the target UE.
{NPL1} 3GPP TR 36.819 v11.0.0, Coordinated multi-point operation for LTE physical layer aspects (Release 11). http://www.3gpp.org/ftp/Specs/archive/36_series/36.819/.
{NPL2} R1-123077, LS on CSI-RSRP and CoMP Resource Management Set, (http://www.3gpp.org/ftp/tsg_ran/WG1_RL1/TSGR1_{—}69/Docs/)
{NPL3} 3GPP TR 36.214 v11.0.0, Physical Channels and Modulation of Evolved Universal Terrestrial Radio Access (E-UTRA); Physical layer; Measurements (Release 11). http://www.3gpp.org/ftp/Specs/archive/36_series/36.214/.
{NPL4} R1-124669, RRC Parameters for Downlink CoMP
{NPL5} Ohwatari, Y., Miki, N., and et. al., “Performance of Advanced Receiver Employing Interference Rejection Combining to Suppress Inter-Cell Interference in LTE-Advanced Downlink”, IEEE VTC-Fall, 2011.
{NPL6} Hui, A. L. C.; Letaief, K. B., “Successive interference cancellation for multiuser asynchronous DS/CDMA detectors in multiplath fading links”, IEEE Transaction on, Page, 384-391, vol. 46, Issue 3, 1998.

### SUMMARY

### Technical Problem

To combat with the interference from the point of the above-mentioned type_{—}1, that is, a point inside CMS, a simple solution is to increase the number of selected TPs for JT or CS/CB points to improve the user throughput of the CoMP UE. However, the improvement for the CoMP UE costs the resources at such a point for other UEs, resulting in the degradation of the other UEs' user throughput.

To consider the interference from the point of the above-mentioned type_{—}2, that is, a point outside CMS, a simple solution is to increase the number of points in the CMS. The dynamic channel state information (CSI) of such a point with high RSRP can be measured and reported from UE to the network to be considered for CoMP scheduling. However, for the CMS with larger number of points, the corresponding reference signals needs complicated network configuration as well as large signaling overhead. Also it is harder to handle the coordinated scheduling for a CMS with a larger size.

Instead of employing CoMP at the transmitter, an advanced receiver with interference suppression (IS) or interference cancellation (IC) has been proposed to improve the performance. The interference suppression (IS) is made by using interference rejection combining (IRC) in NPL5 and the interference cancellation (IC) is made by generating interference replica in NPL6. In NPL6, the channel estimation of the interfering signals is assumed ideally known to achieve good IC performance. In NPL5, without the knowledge of the interfering channel, the correlation of the overall interferences plus AWGN is directly calculated by using the received data and the target UE's DM-RS. However, the performance of IRC receiver in NPL5 is evaluated assuming the Gaussian-distributed inter-cell interference and the channel estimation error may severely degrade the performance due to the limited average number of samples. In the real environment, the inter-cell interference may not follow Gaussian distribution, especially from the point close to the transmission point. Therefore, without the knowledge of the strong interference from the specific point, such as the point of type_{—}1 or type_{—}2, the performance improvement by IS/IC is limited.

### Solution to Problem

An object of the present invention is to provide a method and system which can achieve effective interference suppression/cancelation in downlink coordinated multi-point (CoMP) transmission.

According to the present invention, a radio communication system has a network including multiple points which is capable of communicating with a user equipment, wherein the network signals the user equipment of information related to an interfering point for interference suppression or cancelation at the user equipment, wherein the interfering point is a candidate for a coordinated multi-point measurement set of the user equipment but not selected for any coordinated multi-point scheme.

According to the present invention, a user equipment in a network including multiple points wherein the user equipment is capable of communicating with the multiple points, includes: a radio transceiver for communicating with at least one of the multiple points; and a receiver for receiving data from the network with suppressing or canceling interference from an interfering point based on information related to the interfering point, wherein the interfering point is a candidate for a coordinated multi-point measurement set of the user equipment but not selected for any coordinated multi-point scheme.

According to the present invention, a scheduler in a radio communication system comprising a network including multiple points which is capable of communicating with a user equipment, includes: an interference information configuring section for configuring information related to an interfering point which is a candidate for a coordinated multi-point measurement set of the user equipment but not selected for any coordinated multi-point scheme; and a communication section for sending the information related to the interfering point to the user equipment for interference suppression or cancelation at the user equipment.

According to the present invention, a communication control method in a radio communication system comprising a network including multiple points which is capable of communicating with a user equipment, includes the steps of: selecting an interfering point as a candidate for a coordinated multi-point measurement set of the user equipment but not selected for any coordinated multi-point scheme; and signaling from the network to the user equipment information related to the interfering point for interference suppression or cancelation at the user equipment.

### Advantageous Effects

According to the present invention, effective interference suppression/cancelation at a user equipment can be made in downlink coordinated multi-point (CoMP) transmission.

For a more complete understanding of the present disclosure and its advantages, reference is now made to the following description taken in conjunction with the accompanying drawings, in which like reference numerals represent like parts:

### BRIEF DESCRIPTION OF DRAWINGS

FIG. 1 is a schematic diagram illustrating a radio communication system for explanation of CoMP cooperating set and CoMP measurement set.

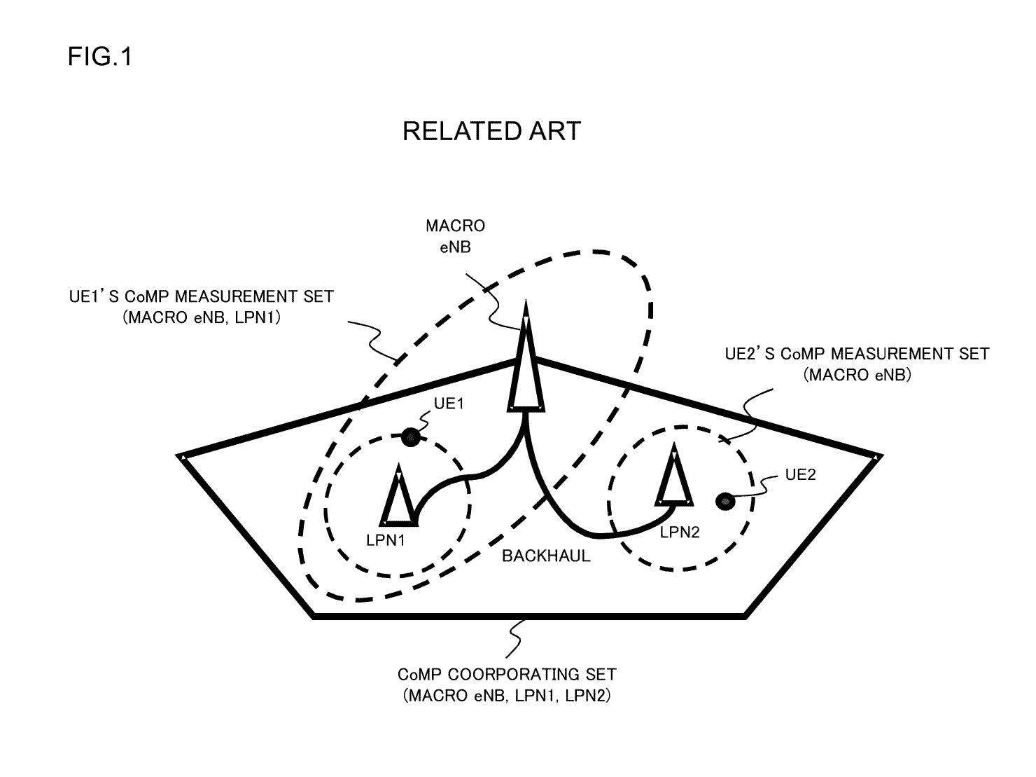

FIG. 2 is a diagram illustrating RSRP for each cell for explanation of RSRP-based decision of CoMP measurement set.

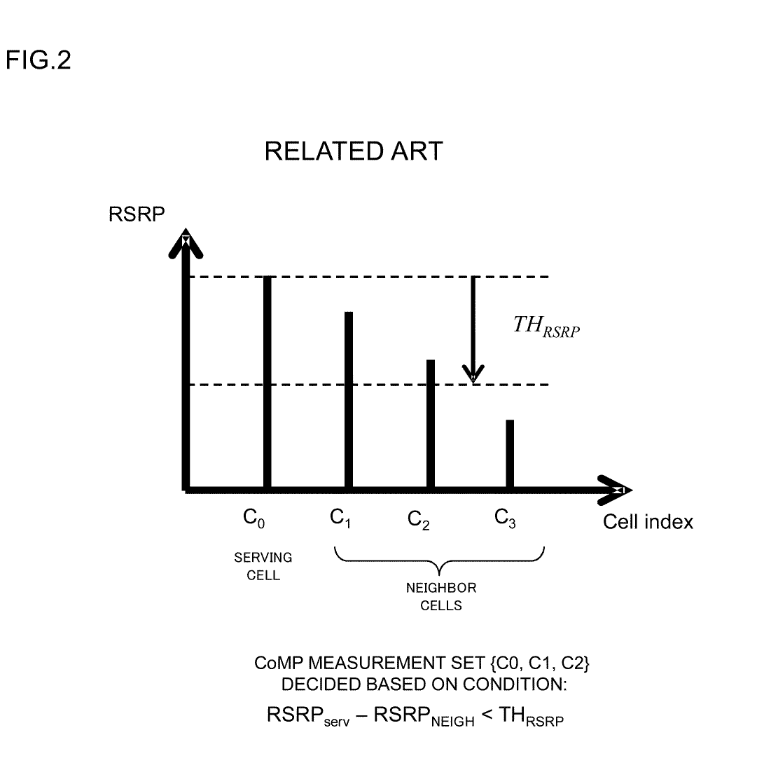

FIG. 3 is a schematic diagram illustrating interference variations in a conventional radio communication system.

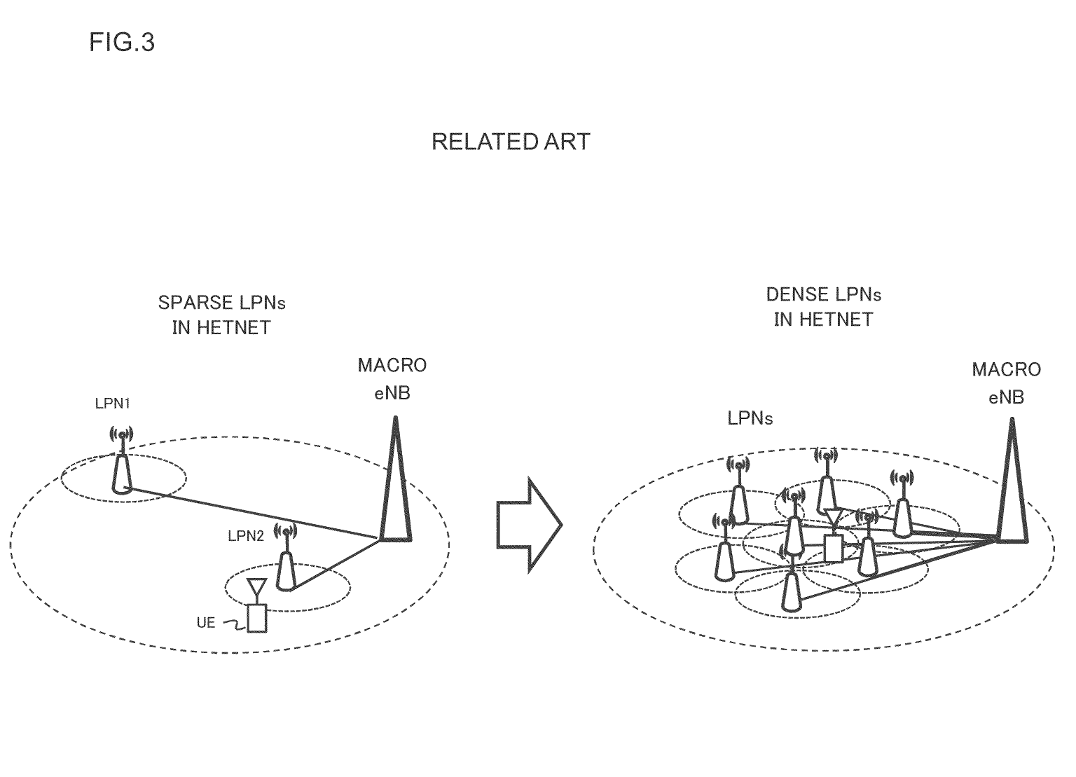

FIG. 4 is a schematic diagram illustrating interferences from transmission points inside CMS and outside CMS in a conventional radio communication system.

FIG. 5 is a diagram illustrating a sequence of interference suppression/cancelation in a radio communication system according to an embodiment of the present invention.

FIG. 6 is a schematic diagram illustrating a radio communication system with centralized scheduling scheme according to an embodiment of the present invention.

FIG. 7 is a schematic diagram illustrating a radio communication system with distributed scheduling scheme according to an embodiment of the present invention.

FIG. 8 is a schematic diagram illustrating a radio communication system according to a first exemplary embodiment of the present invention.

FIG. 9 is a function block diagram illustrating the advanced receiver with IS function in the radio communication system according to the first exemplary embodiment of the present invention.

FIG. 10 is a diagram illustrating a sequence of the signaling for dynamic network-assisted interference suppression or cancellation (IS/IC) at the UE receiver according to the first or the second example of the present invention.

FIG. 11(A) and FIG. 11(B) are diagrams illustrating a table of PQL states and a table of PQI which are used in the signaling as shown in FIG. 9.

FIG. 12(A) and FIG. 12(B) are diagrams illustrating a table of DM-RS indicator per RBG and a table of layer indicator per RBG which may be used in the signaling as shown in FIG. 10.

FIG. 13 is a schematic diagram illustrating a radio communication system according to a second exemplary embodiment of the present invention.

FIG. 14 is a function block diagram illustrating the advanced receiver with IC function in the radio communication system according to the second exemplary embodiment of the present invention.

FIG. 15 is a diagram illustrating a table of modulation indicator per RBG which is used in the signaling of the system as shown in FIG. 13.

### DETAILED DESCRIPTION

Embodiments and examples of the present invention will be explained by making references to the accompanied drawings. The embodiments and examples are used to describe the principles of the present invention by way of illustration only and should not be construed in any way to limit the scope of the disclosure. Those skilled in the art will understand that the principles of the present disclosure may be implemented in any suitably arranged wireless network. In this technical area, a point and a cell may have same meaning, so serving point, cooperating point and neighbor point can be interpreted as serving cell, cooperating cell and neighbor cell, respectively.

### 1. Exemplary Embodiment

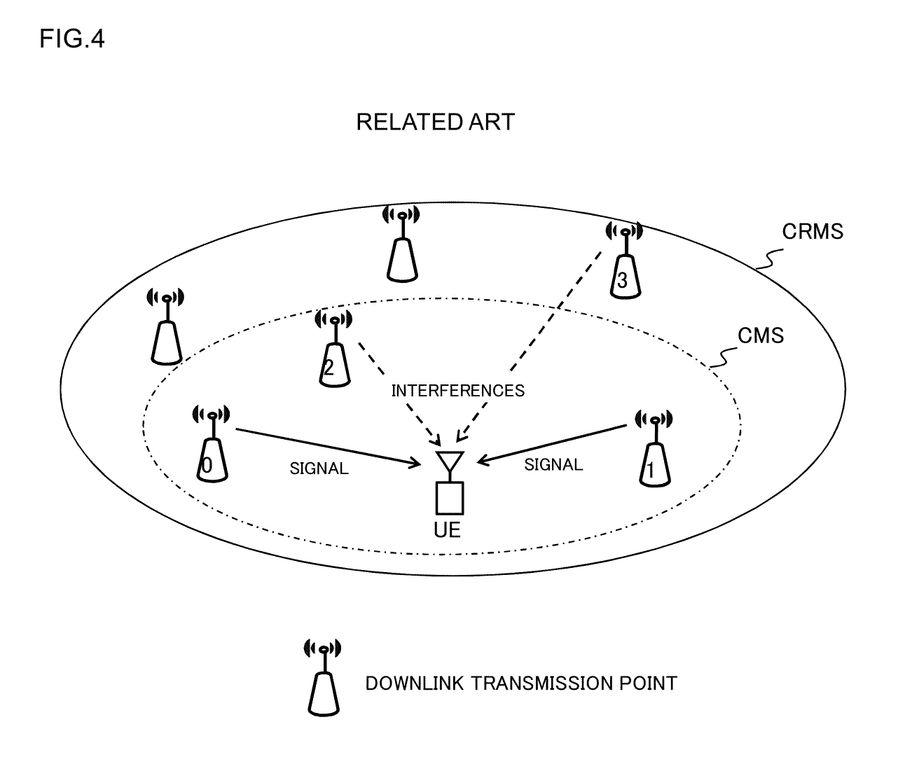

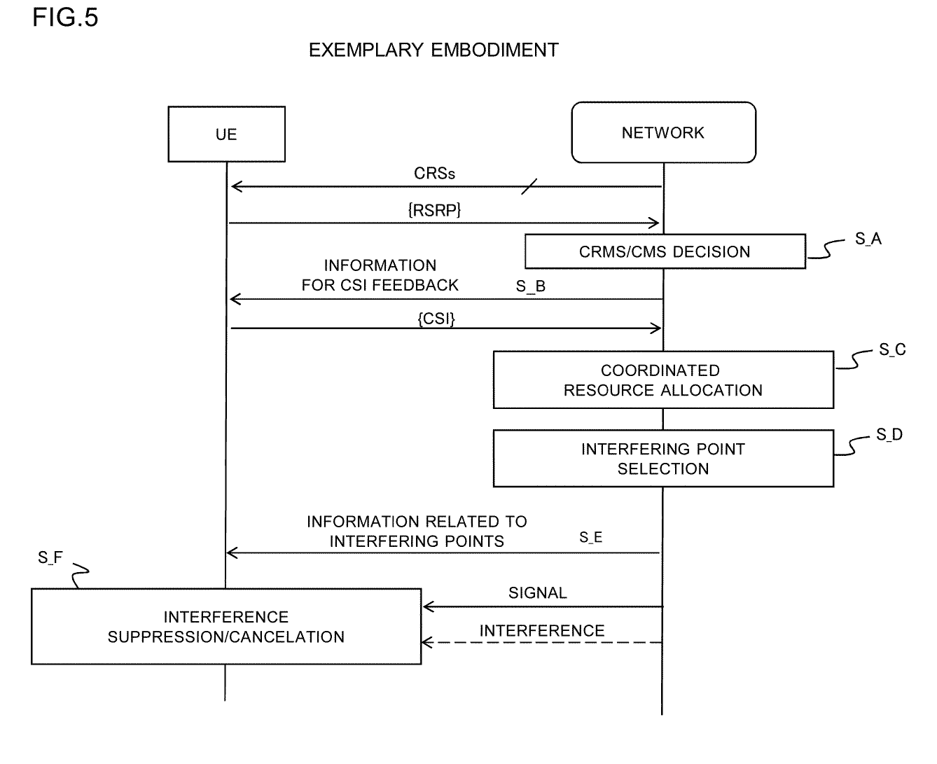

Assuming the case of a network composed of a plurality of transmission points where interferences from some transmission points occur at a user equipment (UE) as shown in FIG. 4, network-assisted interference suppression/cancelation according to an exemplary embodiment of the present invention will be described by referring to FIG. 5.

In FIG. 5, the network decides which transmission point within the CRMS belongs to a CMS of the UE based on reception power information (e.g. RSRP) received from the UE as a response to each cell-specific RS (Operation S_A). For the point(s) in CMS, the network sends the information for the CSI feedback (Operation S_B). Based on the UE CSI feedback, the network performs the coordinated scheduling (Operation S_C). According to the results of CMRS/CMS decision or coordinated resource allocation, the network can select an interfering point which is included in the CRMS but not selected for any CoMP scheme, e.g., JT, DPS, or CS/CB (Operation S_D). Thereafter, the network sends information related to the reference signal used by the selected interfering point to the UE (Operation S_E). The UE detects data sent from a transmission point selected for a CoMP scheme with suppressing/canceling interferences from the selected interfering point (Operation S_F).

Specifically, the network provides the signaling to indicate the reference signal used at a selected interfering point, which is included in the CRMS but neither selected for data transmission nor CS/CB. The reference signal used at the selected interfering point is used for dynamic network-assisted interference suppression or cancellation (IS/IC) at the UE receiver. In the case of interference-limited dense small cell scenarios, the spectrum efficiency can be improved at the price of small signaling overhead.

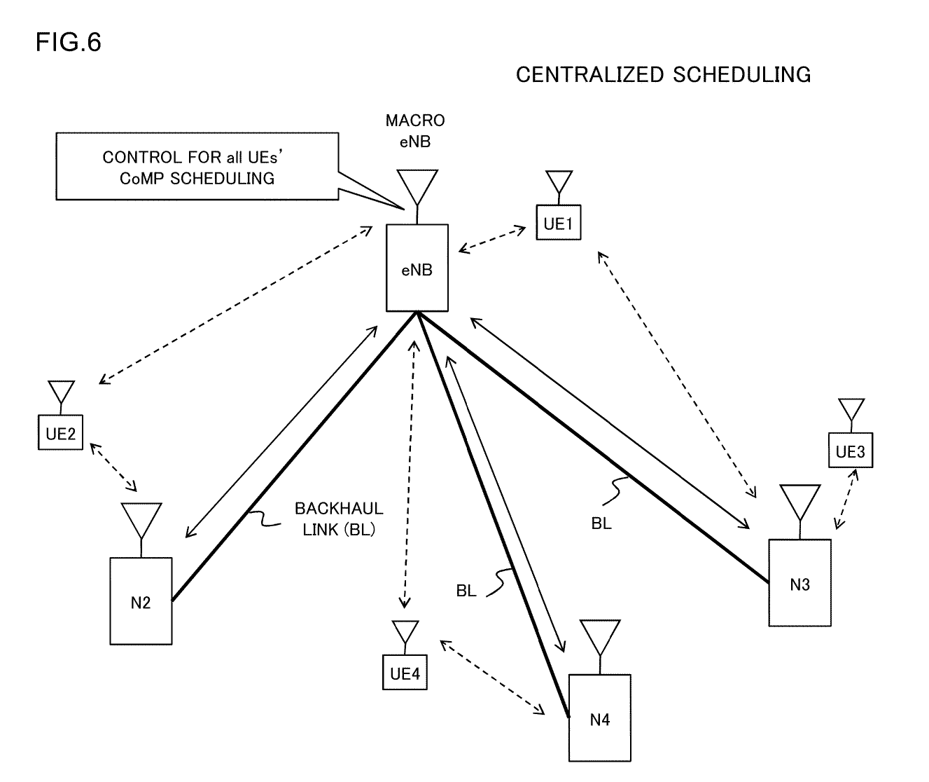

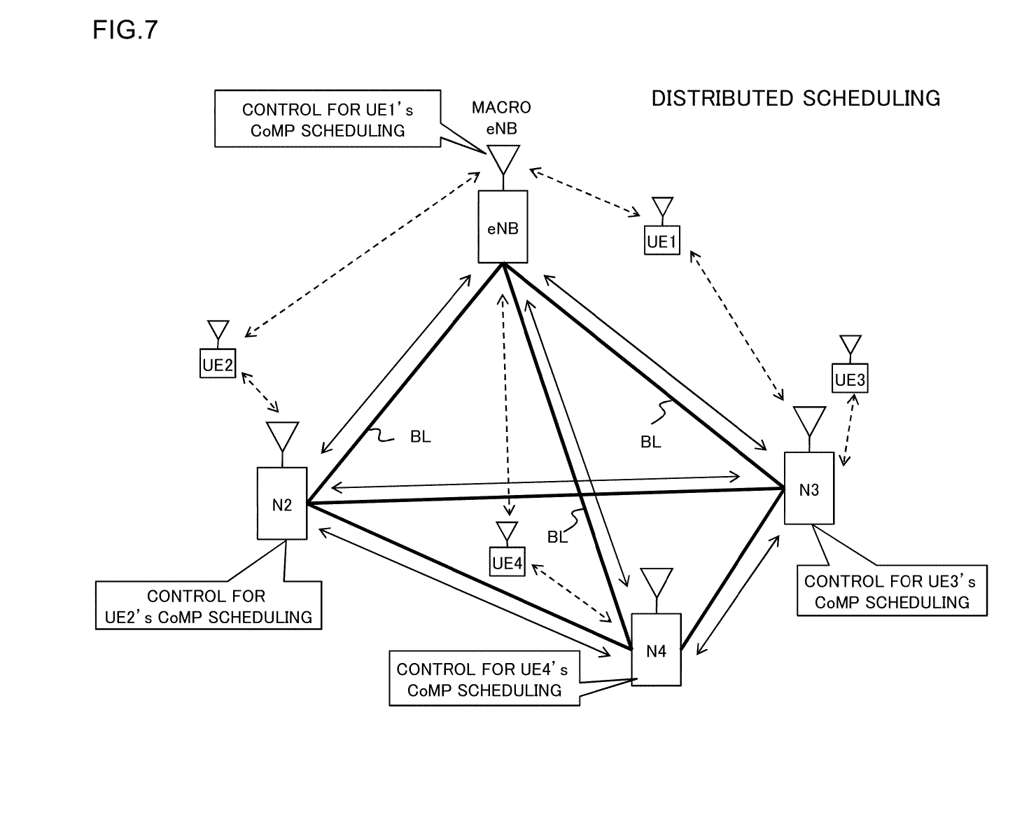

The coordinated scheduling according to the exemplary embodiment can be implemented in a centralized scheduling system as shown in FIG. 6 or a distributed scheduling system as shown in FIG. 7. In other words, the functions of the centralized scheduling can also be distributed into multiple nodes.

### <Centralized Scheduling>

Referring to FIG. 6, it is assumed for simplicity that the centralized scheduling system includes a predetermined radio node (Macro eNB) and multiple radio nodes (N2-N4). Here, the Macro eNB is connected to nodes N2-N4 through backhaul links (BLs) respectively and user equipments UE1-UE4 are served by the Macro eNB and the nodes N2-N4, respectively. The Macro eNB plus nodes N2-N4 are regarded as a CoMP cooperating set. The Macro eNB is provided with a centralized scheduler, which performs the CRMS and CMS decision, reference signal (RS) and PQL configuration as well as coordinated resource allocation for all UEs in the CoMP cooperating set. The details of the coordinated scheduling in the centralized scheduling system will be described later.

### <Distributed Scheduling>

Referring to FIG. 7, it is also assumed for simplicity that the distributed scheduling system includes multiple radio nodes (Macro eNB, nodes N2-N4). Here, the Macro eNB is connected to nodes N2-N4 through BLs and N2-N4 are also connected to each other through BLs. The user equipments UE1-UE4 are served by the Macro eNB and the nodes N2-N4, respectively. In the distributed scheduling system, not only the Macro eNB but also each of the nodes N2-N4 is provided with a distributed scheduler, which is capable of communicating with other distributed schedulers. Each distributed scheduler performs the coordinated scheduling for its serving UE. For instance, the distributed scheduler at the Macro eNB performs control for CRMS and CMS decision for UE1, RS configuration as well as resource allocation coordinated among the neighbor nodes (here, N3) in the UE1's CMS. Similarly, the distributed scheduler at the node N2 performs control for CRMS and CMS decision for UE2, RS and PQL configuration as well as resource allocation coordinated among the neighbor nodes. The coordinated information among the serving node N2 and the point Macro eNB in the UE2's CMS is exchanged over backhaul link. A backhaul link can be optical fiber, DSL, X2 backhaul or wireless link, such as LOS or NLOS microwave.

Hereafter, several examples of the present invention will be explained taking as an example the case of the centralized scheduling. As described above, the functions of the centralized scheduling can also be implemented in the distributed scheduling system.

### 1. FIRST EXAMPLE

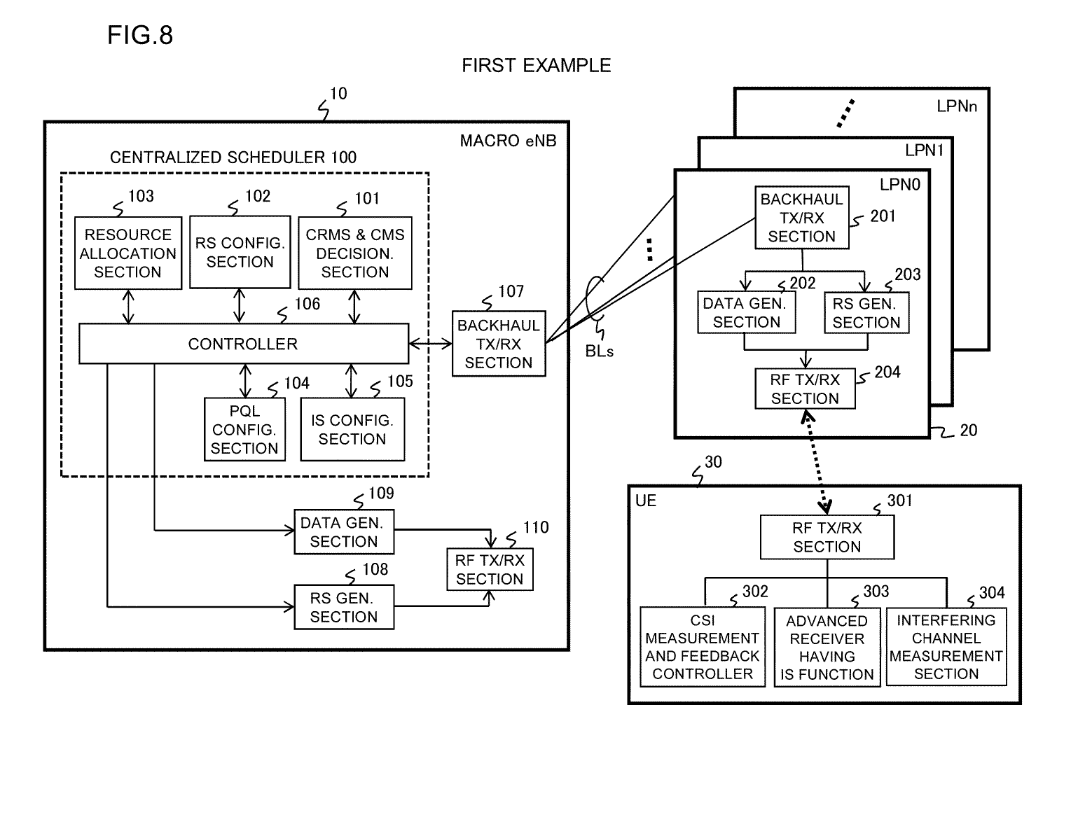

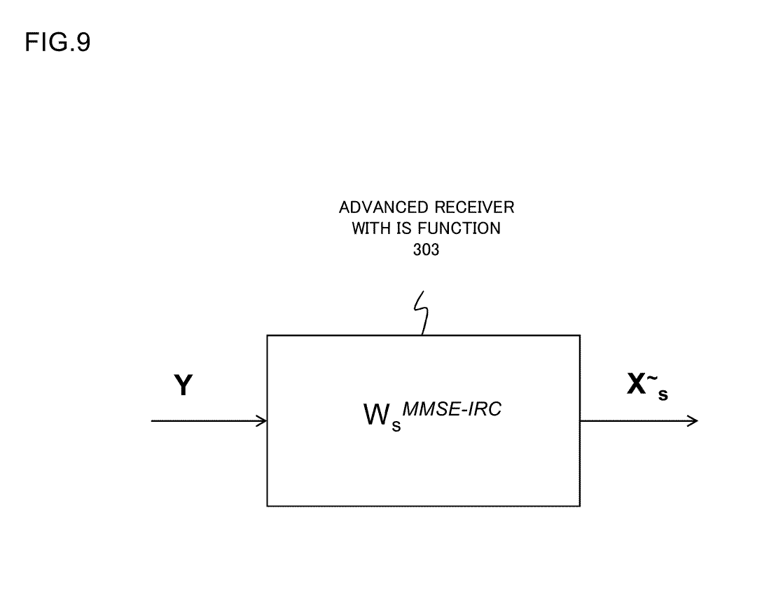

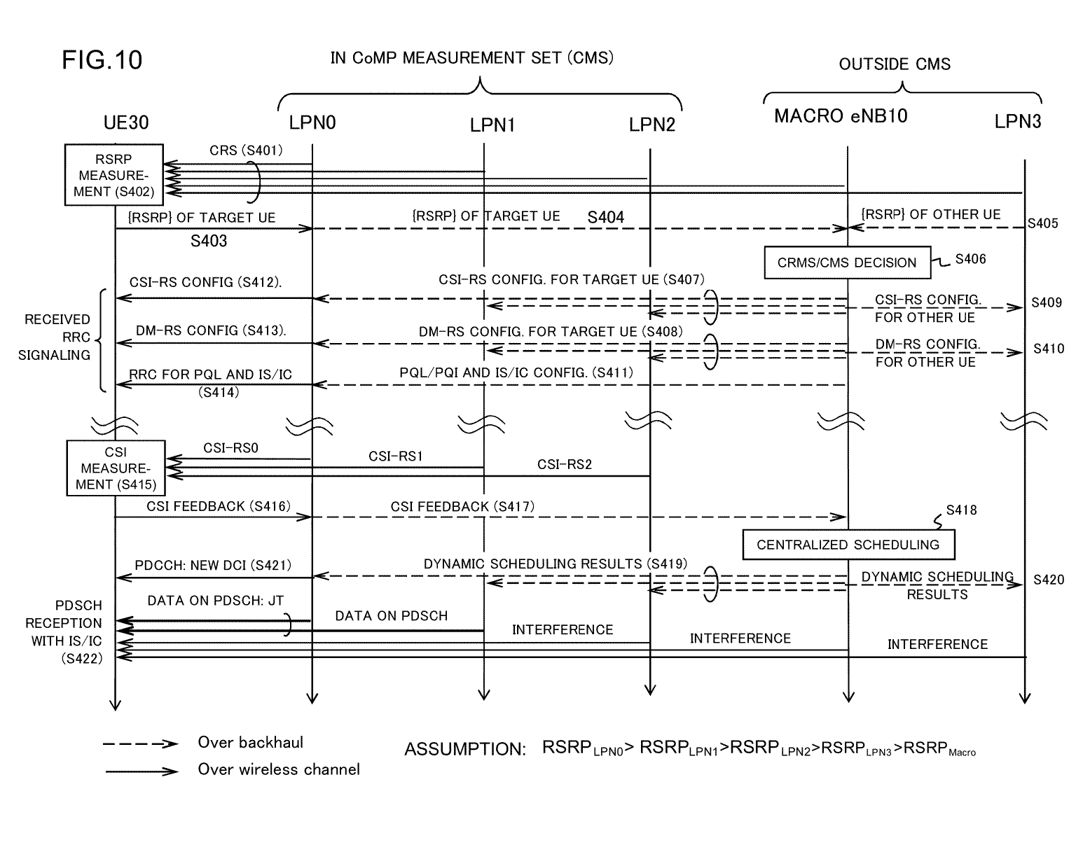

A first example of the exemplary embodiment is used to suppress interference from a point inside or outside the CMS. A system according to the first example is shown in FIGS. 8 and 9. An operation of the present example is illustrated in FIG. 10.

### 1.1) System Structure

As illustrated in FIG. 8, a centralized scheduler 100 is located in Macro eNB 10 to control all the LPNs, LPN0-LPNn, which are connected to the Macro eNB 10 through respective backhaul link (BL). The centralized scheduler 100 includes a CRMS and CMS decision section 101, a RS configuration section 102, a resource allocation section 103, a PQL configuration section 104, a IS configuration section 105, and a controller 106. The CRMS and CMS decision section 101 is in charge of deciding on which point is included in the CRMS and CMS respectively based on the UE reported RSRP. In RS configuration section 102, the CSI-RS and DM-RS are respectively configured for the channel estimation and data demodulation for each UE in the CoMP cooperating set. The resource allocation section 103 is used to allocate each resource block for each point to the UE based on the UEs' CSI feedback. The PQL configuration section 104 is used to configure several states for a CoMP candidate UE to correctly implement PDSCH resource element rate matching as well as channel estimation based on quasi-co-location information. All those blocks are connected to the controller 106.

The configured RS and PQL states as well as the scheduling results are sent from a backhaul TX/RX section 107 of the Macro eNB 10 to the backhaul TX/RX section 201 of each LPN through a corresponding backhaul link. At the serving point LPN0 of the target UE 30, data and reference signals (RS) are generated by a data and RS generation section 202 and 203, respectively and transmitted from the RF TX/RS section 204 to the UE 30.

The UE 30 is composed of a RF TX/RX section 301, a channel measurement and feedback controller 302, an advanced receiver 303 which has Interference Suppression (IS) function, and an interfering channel measurement section 304. The signal channel matrix between each transmission point and the UE 30 is estimated by the channel measurement and feedback controller 302 based on the RS received at RF TX/RX section 301. While, the interfering channel matrix between the interfering point and the UE 30 is estimated by the interfering channel measurement section 304. Based on the estimated signal and interfering channel matrixes, the data is received by using the estimated channel matrix at the advanced receiver 303 based on minimum mean square error with interference rejection combining (MMSE-IRC).

Referring to FIG. 9, the advanced receiver 303 receives the frequency-domain signal Y at the RF TX/RX section 301 to output the signal data X~ₛ which is estimated by using the MMSE-IRC weight Wₛ^{MMSE-IRC} according to the following equation (3):

$$\begin{matrix}\{ Math . 3 \} & \\ {\tilde{X}}_{s} = {W}_{s}^{MMSE - IRC} Y \\ with {W}_{s}^{MMSE - IRC} = \frac{{\tilde{H}}_{s}^{H}}{{\tilde{H}}_{s} {\tilde{H}}_{s}^{H} + {\tilde{H}}_{I} {\tilde{H}}_{I}^{H} + {σ}_{N + {I}^{′}}^{2}} \\ wherein {σ}_{N - {I}^{′}}^{2} is , & ( 3 )\end{matrix}$$

the average noise and average interferences except the interference from the interfering point.

In the equation (3), H~_{I} is the precoded channel of an interfering point and H~ₛ is the precoded channel of a signal transmission point. In order to estimate the precoded channel of the interfering point, H~_{I} with reality, the MMSE-IRC receiver 303 requires the information of reference signal for the interfering point.

In case of centralized scheduling, the centralized scheduler 100 only needs to send the dynamic scheduling results of the interfering point over backhaul links to the serving point LPN0 to decide the new DCI signaling for IS. However, in case of distributed scheduling, the serving point LPN0 should inform the interfering point to trigger or stop the reporting of the dynamic scheduling results for IS.

### 1.2) Operation

Referring to FIG. 10, at the Macro eNB 10, the RS generation section 108 generates the cell-specific RS (CRS) and sends it to the target UE 30 through the RF RX/TX section 110. Similarly, at each of the LPN0-LPN3, the RS generation section 203 generates the cell-specific RS (CRS) and sends it through the RF RX/TX section 204 (Operation S401).

At the UE 30, the channel measurement and feedback controller 302 performs RSRP measurement of CRSs received from different points (the Macro eNB 10 and the LPN0-LPN3) (Operation S402) and reports the estimated {RSRP} of the different points to its serving cell, LPN0, through the RF TX/RX section 301 (Operation S403). The feedback {RSRP} is transferred from the serving cell, LPN0, to the centralized scheduler 100 of the Macro eNB 10 (Operation S404). Similarly, the LPN3 receives the feedback {RSRP} from other UEs and transfers them to the centralized scheduler 100 of the Macro eNB 10 (Operation S405).

Base on the RSRP ranking, the CRMS and CMS decision section 101 decides the UE's CRMS and CMS (Operation S406). Assuming RSRP_{LPN0}>RSRP_{LPN1}>RSRP_{LPN2}>RSRP_{LPN3}>RSRP_{Macro} and five points with RSRPₛₑᵣᵥ-RSRPₚₒᵢₙₜ<TH_{RSRP} are selected into CRMS, maximum 3 points among the five points can be selected into the UE's CMS. In this example, the target UE 30 has the CMS of LPN0 (serving point), LPN1 and LPN2 with RSRP_{LPN0}>RSRP_{LPN1}>RSRP_{LPN2}. The LPN3 and Macro eNB10 belong to the CRMS but outside the CMS with RSRP_{LPN2}>RSRP_{LPN3}>RSRP_{Macro}. Therefore, the target UE 30 is regarded as a CoMP candidate UE.

For such a CoMP candidate UE, the multiple NZP-CSI-RSs and ZP-CSI-RSs are configured for the measurement of required CSI processes in the RS configuration section 102. Also the DM-RSs of corresponding points are also configured with two candidate initialization values of the DM-RS scrambling sequence for each point. The CSI-RS configuration and DM-RS configuration are sent from the Macro eNB 10 to each point in the target UE's CMS through the backhaul links (Operations S407, S408). Also, the CSI-RS configuration and DM-RS configuration for the other UEs are sent from the Macro eNB 10 to the other point in the other UEs' CMS through the backhaul links (Operations S409, S410). In addition, the PQL configuration section 104 and the IS configuration section 105 of the Macro eNB 10 configure PQL together with IS states (PQL/IS states) and send the PQL/IS configurations to the serving cell, LPN0, through the backhaul TX/RX section 107 (Operation S411). Details of the PQL/IS states and corresponding PQL indicator (PQI), which is used to trigger a PQL/IS state, will be described later.

The serving point LPN0 is in charge of informing the target UE 30 of the CSI-RS and DM-RS configurations and PQL/IS and PQI configurations over RRC signaling semi-statically (e.g., every 100 ms) (Operations S412-S414).

Base on the CSI-RS configuration, each LPN in the target UE's CMS generates and sends the NZP-CSI-RS and/or mutes the resources of ZP-CSI-RS to the target UE 30 through the RF RX/TX section 204 periodically (e.g., every 5 ms or 10 ms). With the knowledge of the CSI-RS, the channel measurement and feedback controller 302 of the UE 30 can measure CSIs for signal and interference estimation (Operation S415). Accordingly, the short-term channel state information (CSI), represented by e.g., rank index (RI), precoding matrix index (PMI), channel quality index (CQI), are calculated and reported to its serving point LPN0 over wireless channel, e.g., PUCCH (physical uplink control channel) or PUSCH (physical uplink shared channel) (Operation S416).

The reported CSI is transferred from the serving point LPN0 to the Macro eNB 10 over the backhaul link for centralized scheduling (Operation S417). The resource allocation section 103 of the centralized scheduler 100 dynamically selects the resource blocks at each point in the CMS and allocates the selected resource blocks to the target UE 30 (Operation S418). The dynamic scheduling results, including the selected points, the allocated resource blocks, the selected MCS (Modulation and Coding Set), selected initialization value of the DM-RS scrambling sequence, etc., are informed to the LPN0-LPN3 over respective backhaul links (Operations S419, S420).

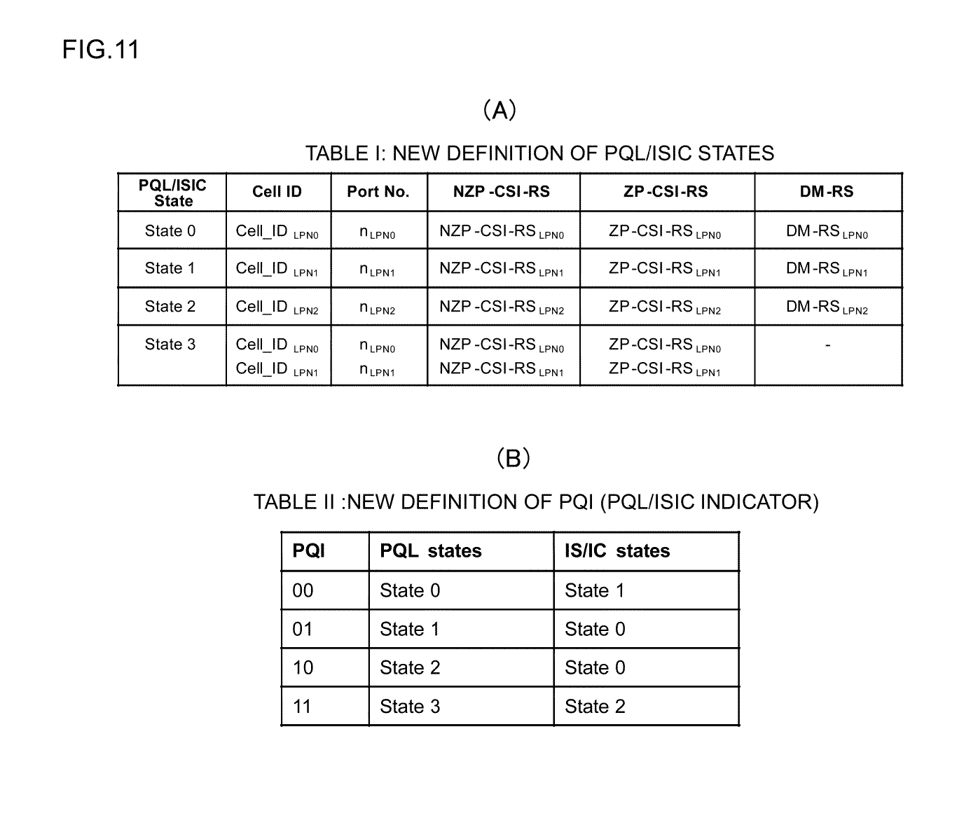

When receiving the dynamic scheduling results from the Macro eNB 10, the serving cell, LPN0, informs the UE 30 of the corresponding PQL/IS state indicated according to the PQI in the DCI, e.g. DCI format 2D or a new DCI format, over the control channel, e.g., PDCCH (physical downlink control channel) or EPDCCH (enhanced PDCCH) (Operation S421). In the present example as shown in FIG. 10, the LPN0 and LPN1 are both selected for synchronized joint transmitting the data of the target UE 30 over PDSCH (physical downlink shared channel). As shown in FIG. 11, the corresponding PQL/IS states, e.g., PQL state 3 and IS state 2, are indicated simultaneously according to the PQI of ‘11’ in the DCI over the control channel. Besides, the other scheduling results for target UE 30, e.g., MCS, allocated resource blocks and dynamically selected DM-RS initialization value, are also dynamically indicated in the DCI for PDSCH reception.

Accordingly, the advanced receiver 303 can receive data on PDSCH from JT points, LPN0 and LPN1, according to the PQL state; while suppressing interference from the selected point for IS according to the IS state, LPN2 inside the CMS or LPN3 outside the CMS. For IS, the interfering channel is estimated by the interfering channel measurement section 304 based on the indicated DM-RS configuration in the IS state (Operation S422). Also, the interfering channel measurement section 304 can further improve the estimation of the un-precoded channel power delay profile from the interfering point by using the CRS and NZP-CSI-RS configuration indicated by the PQL/IS configuration.

As described above, by using the new RRC signaling and DCI signaling to obtain the configured IS information, the network-assisted IS is implemented at the receiver side provided with the advanced receiver 303 together with interfering channel measurement section 304.

Hereafter, the dynamic IS operations in the cases of an interfering point inside the UE's CMS and an interfering point outside the UE's CMS will be described in more detail.

1.3) Suppression of Interference from a Point Inside CMS

As described above, for correct channel estimation and reception of the CoMP candidate UE's PDSCH data, several states are configured at the PQL configuration section 104 to correctly implement PDSCH resource element rate matching as well as channel estimation based on QCL information for possible selected transmission point(s). In LTE Release 11, four PQL states are required to support dynamic point selection in a maximum 3-point CMS. Correspondingly, a 2-bit PQI is required in the DCI, e.g., DCI format 2D, to dynamically indicate one of the four PQL states. Referring to FIG. 11(A), each PQL state in Rel.11 includes the information of a selected TP's cell ID, CRS's port number, zero-power CSI-RS for PDSCH rate matching, NZP CSI-RS for quasi-co-location. For example, assuming the target UE has a CMS of LPN0 (serving point), LPN1 and LPN2 with RSRP_{LPN0}>RSRP_{LPN0}>RSRP_{LPN2}, the PQL state i, i=0, 1, 2, is configured assuming LPNi is the selected TP and the PQL state 3 is configured for a case of JT, for instance, that LPN0 and LPN1 are both selected for joint transmission.

As described before, new RRC signaling is needed for suppressing the interference from the point inside the CMS. In order to save the RRC signaling overhead, the available four PQL states and two PQI bits are reused by adding the information for IS. For IS, the information of the DM-RS is also required besides the CRS and NZP-CSI-RS. To generate a PQL/IS state, the DM-RS configuration for LPNi is added in the PQL state i with i=0, 1, 2, which includes the DM-RS port number, frequency shift as well as the two candidate initialization values of DM-RS scrambling sequence. As illustrated in Table I of FIG. 11(A), a combined PQL/IS state i, i=0, 1, 2, is configured assuming LPNi is the selected TP or the selected IS point for the target UE. Accordingly, by selecting one of the four states 0-3, a point for the selected CoMP scheme or an interfering point for IS can be determined.

The PQI, conventionally used for indicating the selected TP, is newly defined as Table II of FIG. 11(B) to simultaneously indicate a PQL state for the dynamically selected point and a IS state for the dynamically selected interfering point, where the non-selected point with strongest RSRP among the non-selected TPs inside the CMS is chosen as the point for IS at the advanced receiver 303. For example, considering RSRP_{LPN0}>RSRP_{LPN1}>RSRP_{LPN2}, the PQL state=State0 in PQI ‘00’ indicates that LPN0 is selected as the TP and the IS state=State1 in PQI ‘00’ represents that the interference from LPN1 is selected for IS. In case of PQI=‘11’, the PQL state 3 is triggered to indicate LPN0 and LPN1 are both selected for joint transmission as shown in FIG. 10; while, the IS state=State2 is simultaneously triggered which indicates the information of LPN2 in Table I as the interfering point.

The newly defined PQL/IS states as well as the newly defined PQI table are firstly transferred from Macro eNB 10 to the serving point LPN0 through the backhaul link and then sent from the LPN0 to the target UE 30 over RRC signaling semi-statically (e.g., every 100 ms) in PDSCH.

The interfering channel measurement section 304 of the UE 30 can use the newly defined PQL/IS sate to estimate the un-precoded channel from the interfering point by using the CRS and NZP-CSI-RS configuration and also to estimate the precoded channel from the interfering point by using the DM-RS configuration.

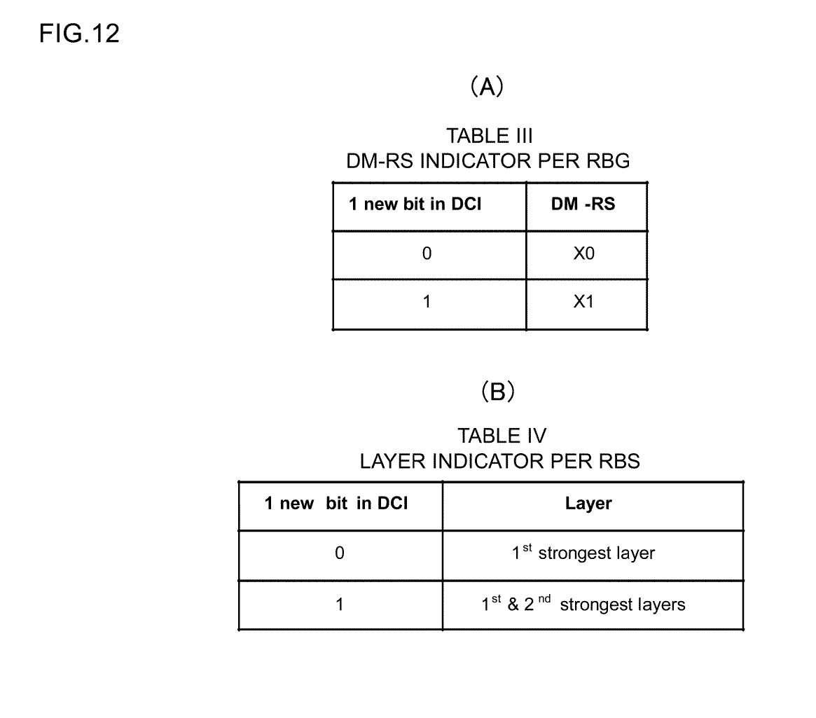

On the other hand, the initialization value of DM-RS scrambling sequence can be dynamically selected for different interfering UE on different resource block group (RBG) allocated for the target UE 30. Therefore, a new bit of DM-RS indicator per RBG in Table III as shown in FIG. 12(A) may be needed in the DCI to indicate the dynamically selected initialization value of DM-RS scrambling sequence for different interfering UE. Since the default value of DM-RS scrambling sequence is the cell ID, which is used by most UEs with SU-MIMO or UEs without CoMP, the DM-RS indicator bit is not needed for suppressing or cancelling the interference from such UEs. For further overhead reduction, it is possible that the DM-RS indicator per RBG is not added in the DCI.

In addition, another bit, defined as the layer indicator in Table IV as shown in FIG. 12(B), may be required in the DCI per RBG to inform the UE the strongest one or two layers for IS/IC. Although more than 2 layers may be precoded at the transmitter, the strongest two layers are selected here for IS to achieve most gain with minimum additional bit in the new defined DCI. Accordingly, the overhead of DCI is reduced without too much performance loss. Further overhead reduction with no layer indicator is also possible by detecting the strongest layer of the interfering channel by default.

With the network assistance of the new RRC signaling, e.g., PQL/IS states and PQI table (see FIG. 11), as well as the new DCI signaling, e.g., DM-RS indicator and layer indicator (see FIG. 12), the UE 30 is able to estimate the interfering channel from LPN2 and suppress the interference inside the CMS by using the MMSE with interference rejection combining (MMSE-IRC) at the advanced receiver 303.

Assuming the interfering channel matrix of LPN2 is estimated as H~_{I}=Ĥ₂, the advanced receiver 303 receives the frequency-domain signal Y at the RF TX/RX section 301 to output the signal data X~ₛ which is estimated by using the MMSE-IRC weight Wₛ^{MMSE-IRC} according to the equation (3) with

σ_{N+1′}² {Math. 4}

is the average noise and the average interferences except the interference from LPN2.
1.4) Suppression of Interference from a Point Outside CMS

Based on the ranking of RSRP, the point with highest RSRP outside the CMS is semi-statically selected for IS, e.g., LPN3 as illustrated in FIG. 10. For such a point, the new RRC signaling is needed to indicate the information of LPN3, including the configuration of CRS, NZP-CSI-RS, and DM-RS, etc. As described before, the interfering channel measurement section 304 of the UE 30 can estimate the un-precoded channel from the interfering point LPN3 by using the CRS and NZP-CSI-RS configuration as well as the precoded channel from the interfering point by using the DM-RS configuration.

Assuming the interfering channel matrix of LPN3 is estimated as H~_{I}=Ĥ₃, the advanced receiver 303 receives the frequency-domain signal Y at the RF TX/RX section 301 to output the signal data X~ₛ which is estimated by using the MMSE-IRC weight Wₛ^{MMSE-IRC} according to the equation (3) with

σ_{N+1′}² {Math. 5}

is the average noise and the average interferences except the interference from LPN3.

### 2. SECOND EXAMPLE

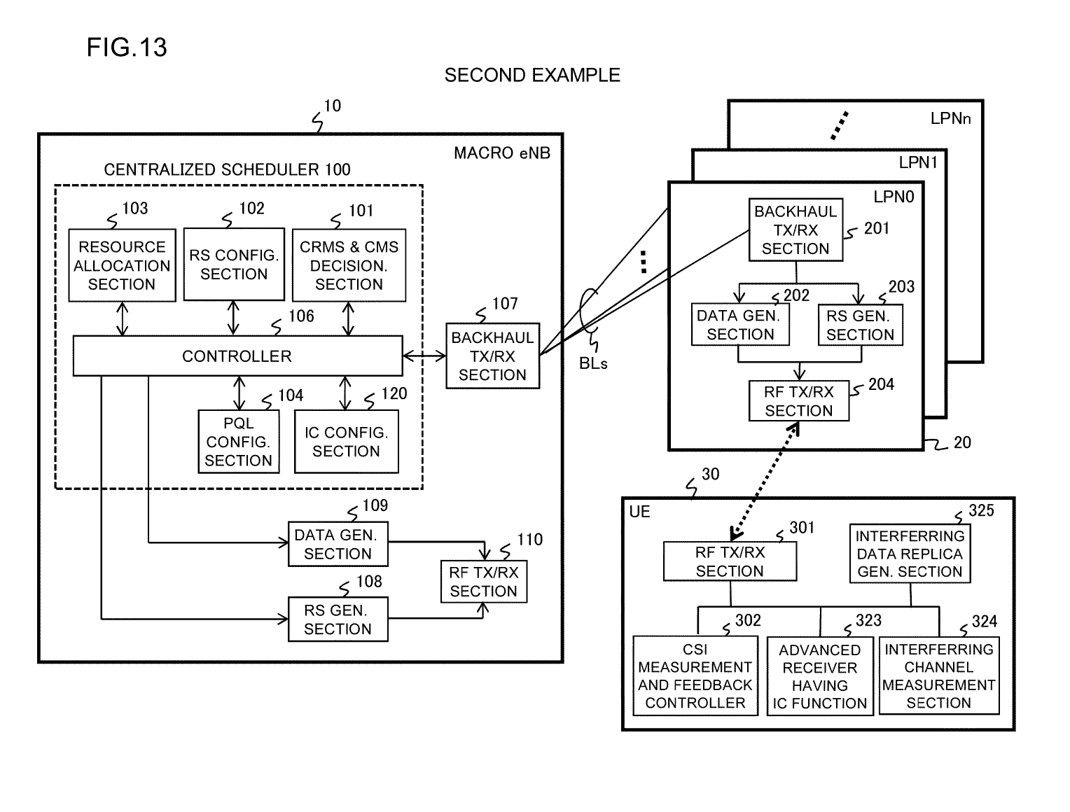

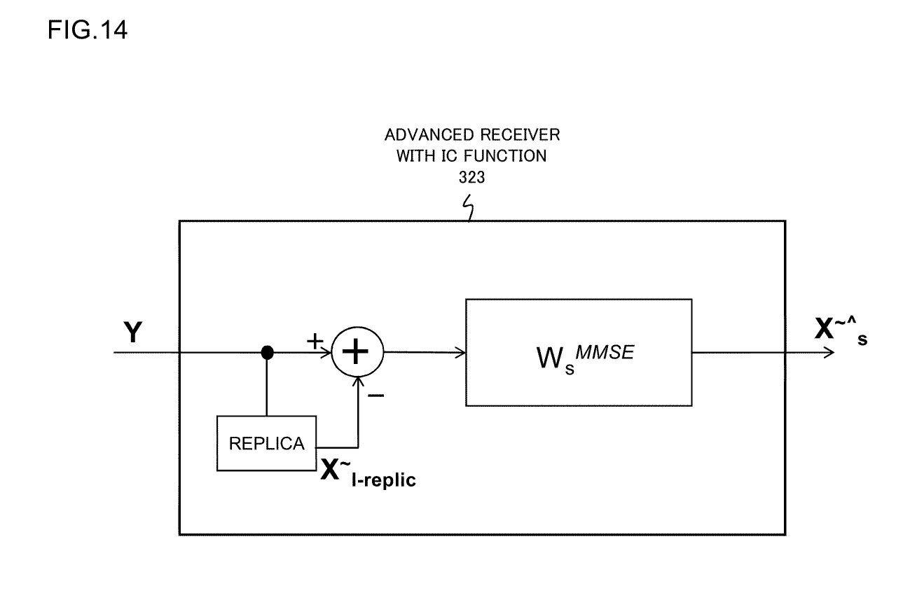

A second example of the exemplary embodiment is used to cancel interference from a point inside or outside the CMS. A system according to the second example is shown in FIGS. 13 and 14. An operation of the present example is illustrated in FIG. 10.

### 2.1) System Structure

Referring to FIG. 13, the system structure of the second example is basically identical to that of the first example as shown in FIG. 8 except that the Macro eNB 10 is provided with an IC configuration section 120 replacing the IS configuration section 105 of the first example and the UE 30 is provided with an advanced receiver 323 which has an IC function replacing the advanced receiver 303, an interfering channel measurement section 324 replacing the interfering channel measurement section 304 and an interfering data replica generation section 325. Accordingly, other blocks similar to those previously described with reference to FIG. 8 are denoted by the same reference numerals and details are omitted.

According to the second example, the new RRC signaling and new DCI signaling are used to obtain the configured IC information, allowing the network-assisted IC to be implemented at the receiver side by the advanced receiver 323, the interfering channel measurement section 324 and the interfering data replica generation section 325.

Referring to FIG. 14, the advanced receiver 323 generates a replica X~_{1-replica}, of the interfering data and outputs the interference-canceled signal data X~̂ₛ which is estimated according to the following procedure.

Firstly, the interfering channel measurement section 324 estimates the interfering channel matrix of an interfering point as H~_{I}. Using the same method as described in 1.3) of the first example, the signal data X~ₛ is estimated by using the MMSE-IRC weight Wₛ^{MMSE-IRC} according to the equation (3).

Next, the interfering data replica generation section 325 firstly estimates the interfering data by using the MMSE weight according to the following equation (4):

$$\begin{matrix}\{ Math . 6 \} & \\ {\tilde{X}}_{I} = {W}_{I}^{MMSE} ( Y - {\tilde{H}}_{s} {\tilde{X}}_{s} ) \\ with {W}_{I}^{MMSE} = \frac{{\tilde{H}}_{I}^{H}}{{\tilde{H}}_{I} {\tilde{H}}_{I}^{H} + {σ}_{N + {I}^{′}}^{2}} . & ( 4 )\end{matrix}$$

Thereafter, the interfering data X~_{I} can be detected by using the maximum likelihood detection (MLD) with the knowledge of the modulation scheme. The replica X~_{I-replica} is then generated by re-modulation using the same modulated scheme. Finally, the advanced receiver 323 estimates the signal data X~̂ₛ after cancelling the replica X~_{I-replica} according to the following equation (5):

$$\begin{matrix}\{ Math . 7 \} & \\ {\hat{\tilde{X}}}_{s} = {W}_{s}^{MMSE} ( Y - {\tilde{H}}_{I} {\tilde{X}}_{I - replica} ) \\ with {W}_{s}^{MMSE} = \frac{{\tilde{H}}_{s}^{H}}{{\tilde{H}}_{s} {\tilde{H}}_{s}^{H} + {σ}_{N + {I}^{′}}^{2}} \\ wherein {σ}_{N + {I}^{′}}^{2} is , & ( 5 )\end{matrix}$$

the average noise and the average interferences except the interference from the interfering point.

### 2.2) Operation

The operation of the second example has the same sequence as the first example as shown in FIG. 10 except that IS is replaced with IC in the operations S411, S414 and S422. Accordingly, hereinafter, based on the system shown in FIG. 13, how to configure and signaling the information for the network-assisted IC of interference inside or outside the CMS are illustrated by referring to FIGS. 10, 13 and 15.

Accordingly, the advanced receiver 323 can receive data on PDSCH from JT points, LPN0 and LPN1, according to the PQL/IS state while canceling interference from the selected point for IC, LPN2 inside the CMS, or LPN3 outside the CMS. The interfering channel is estimated by the interfering channel measurement section 324 based on the DM-RS configuration in the IC state, wherein the PQL/IC state is triggered by the PQI/IC in the DCI (Operation S422). Besides, the scheduling results for target UE 30 are also dynamically indicated in the DCI format 2D for PDSCH reception.

As described above, by using the new RRC signaling and new DCI signaling to obtain the configured IC information, the network-assisted IC is implemented at the receiver side provided with the advanced receiver 323 together with interfering channel measurement section 324 and the interfering data replica generation section 325.

Hereafter, the dynamic IC operations in the cases of an interfering point inside the UE's CMS and an interfering point outside the UE's CMS will be described in more detail.

2.3) Cancellation of Interference from a Point Inside CMS

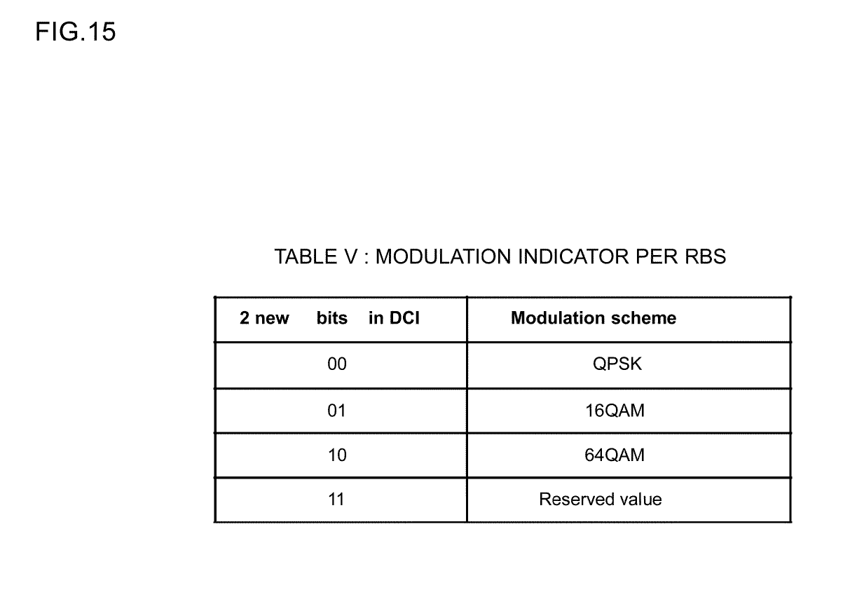

Besides the estimation of the interfering channel by using the IS information described in 1.3) of the first example, the replica generation of the interfering data is required for further canceling the interference data of LPN2 inside the CMS. Therefore, besides the above signaling of the first example, new DCI bits to indicate the dynamic modulation and coding scheme are required for different interfering UE allocated on the same RBG. For example, two DCI bits of Modulation indicator per RBG are illustrated in Table V as shown in FIG. 15. In the presence of the modulation scheme, the received interfering can be demodulated and the replica of the modulated interfering data can be generated.

Firstly, the interfering channel measurement section 324 estimates the interfering channel matrix of LPN2 as H~_{I}=Ĥ₂. Using the method in the first example, the signal data can be firstly estimated by using the MMSE-IRC weight according to the equation (3) with

σ_{N+1′}² {Math. 8}

is the average noise and average interferences except the interference from LPN2.

Next, the interfering data replica generation section 325 firstly estimates the interfering data by using the MMSE weight according to the equation (4).

Thereafter, the interfering data X~_{I} can be detected by using the maximum likelihood detection (MLD) with the knowledge of the modulation scheme. The replica X~_{I-replica} is then generated by re-modulation using the same modulated scheme. Finally, the advanced receiver 323 estimates the signal data X~̂ₛ after cancelling the replica X~_{I-replica} according to the equation (5).

2.4) Cancellation of Interference from a Point Outside CMS

Besides the estimation of the interfering channel by using the IS information described above, the replica generation of the interfering data is required for further canceling the interference data of LPN3. Therefore, besides the above RRC and DCI signaling described in 2.3), new DCI bits to indicate the dynamic modulation and coding scheme are required for different interfering UE allocated on the same RBG. For example, two DCI bits of Modulation indicator per RBG are illustrated in Table V as shown in FIG. 15. In the presence of the modulation scheme, the received interfering can be demodulated and the replica of the modulated interfering data can be generated.

Firstly, the interfering channel measurement section 324 estimates the interfering channel matrix of LPN3 as H~_{I}=Ĥ₃. Using the method described in 1.3) of the first example, the signal data can be firstly estimated by using the MMSE-IRC weight according to the following equation (3) with

σ_{N+1′}² {Math. 9}

is the average noise and the average interferences except the interference from LPN3.

Next, the interfering data replica generation section 325 firstly estimates the interfering data by using the MMSE weight according to the equation (4).

Thereafter, the interfering data X~_{I} can be detected by using the maximum likelihood detection (MLD) with the knowledge of the modulation scheme. The replica X~_{I-replica} is then generated by re-modulation using the same modulated scheme. Finally, the advanced receiver 323 estimates the signal data X~̂ₛ after cancelling the replica X~_{I-replica} according to the equation (5).

### INDUSTRIAL APPLICABILITY

The present invention can be applied to a mobile communications system employing coordinated scheduling among multiple TPs.

1. A radio communication system comprising a network including multiple points which are capable of communicating with a user equipment,
wherein the network sends information related to an interfering point to the user equipment for interference suppression or cancelation at the user equipment,
wherein the interfering point is a candidate for a coordinated multi-point measurement set of the user equipment but not selected for any coordinated multi-point scheme.

2. The radio communication system according to claim 1, wherein the information related to the interfering point includes reference signal configuration used by the interfering point.

3. The radio communication system according to claim 1, wherein the user equipment comprises a receiver having an interference suppression function based on the information related to the interfering point.

4. The radio communication system according to claim 1, wherein the user equipment comprises a receiver having an interference cancelation function based on the information related to the interfering point.

5. The radio communication system according to claim 1, wherein when the interfering point is a point included in the coordinated multi-point measurement set, the network sends first information on possible point selection within the coordinated multi-point measurement set to the user equipment.

6. The radio communication system according to claim 5, wherein the network sends second information for triggering a single point selection from the first information to the user equipment.

7. The radio communication system according to claim 5, wherein the first information includes a predetermined number of states, each of which indicates a different point selection to which the information related to the interfering point is added.

8. The radio communication system according to claim 1, wherein when the interfering point is a point out of the coordinated multi-point measurement set, the network sends the information related to at least one interfering point to the user equipment, wherein said at least one interfering point is selected in descending ranking of received power at the user equipment.

9. A user equipment in a network including multiple points wherein the user equipment is capable of communicating with the multiple points, comprising:
a radio transceiver for communicating with at least one of the multiple points; and
a receiver for receiving data from the network with suppressing or canceling interference from an interfering point based on information related to the interfering point,
wherein the interfering point is a candidate for a coordinated multi-point measurement set of the user equipment but not selected for any coordinated multi-point scheme.

10. The user equipment according to claim 9, wherein the information related to the interfering point includes reference signal configuration used by the interfering point.

11. The user equipment according to claim 9, wherein when the interfering point is a point included in the coordinated multi-point measurement set, the radio transceiver receives from the network first information on possible point selection within the coordinated multi-point measurement set.

12. The user equipment according to claim 11, wherein the radio transceiver receives from the network second information for triggering a single point selection from the first information.

13. The user equipment according to claim 11, wherein the first information includes a predetermined number of states, each of which indicates a different point selection to which the information related to the interfering point is added.

14. The user equipment according to claim 9, wherein when the interfering point is a point out of the coordinated multi-point measurement set, the radio transceiver receives from the network the information related to at least one interfering point which is selected in descending ranking of received power at the user equipment.

15. A scheduler in a radio communication system comprising a network including multiple points which are capable of communicating with a user equipment, comprising:
an interference information configuring section for configuring information related to an interfering point which is a candidate for a coordinated multi-point measurement set of the user equipment but not selected for any coordinated multi-point scheme; and
a communication section for sending the information related to the interfering point to the user equipment for interference suppression or cancelation at the user equipment.

16. The scheduler according to claim 15, wherein the information related to the interfering point includes reference signal configuration used by the interfering point.

17. The scheduler according to claim 15, wherein when the interfering point is a point included in the coordinated multi-point measurement set, the interference information configuring section signals the user equipment of first information on possible point selection within the coordinated multi-point measurement set.

18. The scheduler according to claim 17, wherein the interference information configuring section signals the user equipment of second information for triggering a single point selection from the first information.

19. The scheduler according to claim 17, wherein the first information includes a predetermined number of states, each of which indicates a different point selection to which the information related to the interfering point is added.

20. The scheduler according to claim 15, wherein when the interfering point is a point out of the coordinated multi-point measurement set, the interference information configuring section signals the user equipment of the information related to at least one interfering point which is selected in descending ranking of received power at the user equipment.

21. The scheduler according to claim 15, wherein the scheduler performs centralized scheduling in a macro base station included in the network.

22. The scheduler according to claim 15, wherein the scheduler performs distributed scheduling among a plurality of points included in the network.

23. A communication control method in a radio communication system comprising a network including multiple points which are capable of communicating with a user equipment, comprising:
selecting an interfering point as a candidate for a coordinated multi-point measurement set of the user equipment but not selected for any coordinated multi-point scheme; and
signaling from the network to the user equipment information related to the interfering point for interference suppression or cancelation at the user equipment.

24. The communication control method according to claim 23, wherein the information related to the interfering point includes reference signal configuration used by the interfering point.

25. The communication control method according to claim 23, further comprising: at the user equipment, suppressing interference based on the information related to the interfering point.

26. The communication control method according to claim 23, further comprising: at the user equipment, canceling interference based on the information related to the interfering point.

27. The communication control method according to claim 23, further comprising: when the interfering point is a point included in the coordinated multi-point measurement set, signaling the user equipment of first information on possible point selection within the coordinated multi-point measurement set.

28. The communication control method according to claim 27, further comprising:
signaling the user equipment of second information for triggering a single point selection from the first information.

29. The communication control method according to claim 27, wherein the first information includes a predetermined number of states, each of which indicates a different point selection to which the information related to the interfering point is added.

30. The communication control method according to claim 23, further comprising: when the interfering point is a point out of the coordinated multi-point measurement set, signaling the user equipment of the information related to at least one interfering point which is selected in descending ranking of received power at the user equipment.

31. A receiving method in a user equipment of a network including multiple points wherein the user equipment is capable of communicating with the multiple points, comprising:
communicating with at least one of the multiple points; and
receiving data from the network with suppressing or canceling interference from an interfering point based on information related to the interfering point, wherein the interfering point is a candidate for a coordinated multi-point measurement set of the user equipment but not selected for any coordinated multi-point scheme.

32. A communication control method in a network including multiple points which are capable of communicating with a user equipment, comprising:
configuring information related to an interfering point which is a candidate for a coordinated multi-point measurement set of the user equipment but not selected for any coordinated multi-point scheme; and
signaling the information related to the interfering point to the user equipment for interference suppression or cancelation at the user equipment.

33. The radio communication system according to claim 1, wherein for the interfering point, which is configured for coordinated CSI measurement of coordinated multipoint transmission, the information related to such a point is indicated by
firstly, reusing the sets with each set defined for data rate matching and quasi-co-location for one of the mentioned points, with additional information of the demodulation reference signal configuration at the corresponding point for network-assisted interference suppression/cancellation; and
secondly, sending signaling to trigger one of the above sets to select a point for network-assisted interference suppression/cancellation.

34. The radio communication system according to claim 1, wherein for the interfering point, which is not configured for coordinated CSI measurement of coordinated multipoint transmission, the information related to such a point is indicated by
sending signaling to inform reference signal configuration for network-assisted interference suppression/cancellation.
